(19) United States
(12) Patent Application Publication
(10) Pub. No.: US 2001/0031081 A1
(43) Pub. Date: Oct. 18, 2001

(54) Mirror to be formed using digital image processing and medium storing program for a computer to perform the processing

(75) Inventors: Long Quan, Montbonnot (FR); Takeo Miyazawa, Mitaka-shi (JP); Hima Furuta, Kamakura-shi (JP)

Correspondence Address: OLIFF & BERRIDGE, PLC, 277 S. WASHINGTON STREET, SUITE 500, ALEXANDRIA, VA, 22314, US

(73) Assignee: The One Infinite Inc.

(21) Appl. No.: 09/759,148

(22) Filed: Jan. 16, 2001

Related U.S. Application Data
(60) Provisional application No. 60/199,002, filed on Apr. 19, 2000.

(51) Int. Cl. G06K 9/00; G06K 9/46; G06K 9/66

(52) U.S. Cl. 382/154; 382/190

(57) ABSTRACT

The present invention aims at providing a mirror realized through novel digital image processing that is completely different from conventional mirrors.

The present invention comprises a plurality of imaging devices for respectively obtaining images of an object seen from various viewpoints; a front view image generating unit for identifying the three-dimensional shape of said object based on a plurality of images obtained from said plurality of imaging devices, and generating an image of said object based on the identified results; a signal processing unit for receiving the output from said front view image generating unit and performing a predetermined signal processing; and a display device for displaying an image based on the output from said signal processing unit; wherein said plurality of imaging devices are arranged in the surrounding of said display device, and when said object is placed in front of said display device, said front view image generating unit generates the front view image of said object viewed from said display device, and a mirror image of said object is displayed on said display device.

### BACKGROUND OF THE INVENTION

1. Field of Invention

The present invention relates to a mirror realized by digital image processing to substitute a conventional mirror, and a medium storing a program for causing a computer to implement such processing, wherein the mirror shows an object just like a conventional mirror, and makes digital image processing of a high level possible.

2. Related Art

Conventionally, when one tried to take a picture of one's own face shown in a mirror from the front of the mirror, the camera was displayed in the picture. One way of avoiding this is to use a half mirror as the mirror, and install the camera inside the mirror. However, such a device is complicated in structure, and is used only for very special purposes.

Due to recent improvements in digital image processing technologies, it is becoming possible to automatically restore a three-dimensional shape from two-dimensional images taken from a plurality of different viewpoints, and thereafter re-displaying a new two-dimensional image from an arbitrary viewpoint. By using this technology, it is possible to realize a conventional mirror through digital image processing technology. By realizing this type of device, it would be possible to provide a device that is not the conventional combination of a display device and an image pickup device, and use it for various purposes.

It is an object of the present invention to provide a digital mirror, a novel device that is completely different from conventional mirrors.

### SUMMARY OF INVENTION

The mirror realized through digital image processing according to the present invention is characterized in comprising a plurality of imaging devices for respectively obtaining images of an object seen from various viewpoints; a front view image generating unit for identifying the three-dimensional shape of said object based on a plurality of images obtained from said plurality of imaging devices, and generating a two-dimensional image viewing said object from a viewpoint given based on the identified three-dimensional shape; a signal processing unit for receiving the output from said front view image generating unit and performing a predetermined signal processing; and a display device for displaying an image,based on the output from said signal processing unit; wherein said plurality of imaging devices are arranged in the surrounding of said display device, and when said object is placed in front of said display device, said front view image generating unit generates the front view image of said object viewed from said display device, and a mirror image of said object is displayed on said display device.

For example, there are notebook-type personal computers with CCD cameras provided around a slim liquid crystal display device (LCD), but these CCD cameras cannot capture images viewing the object (e.g., user) from the front, but can only gain images from a slanting direction. This is because the camera cannot be arranged in the center of the LCD where it can view the user from the front. The front view image generating unit generates a view of the object (user) gained when looking at the own face reflected on a mirror. “Front” as used herein is only used for purposes of convenience, and is not limited to only the “front” direction. In short, an image gained when looking at a mirror is meant. Furthermore, a mirror view is normally left and right sides reversed, but as used herein, cases where the sides are not reversed are also included. “Mirror view” as used herein includes images reflected on a mirror, images that may be reflected on a mirror, images reflected on a mirror that do not seem unnatural, and images that attract people when reflected on a mirror.

For reference, the processing procedure from the aspect of processing via a computer is as follows. (1) The shot image and feature points are only two-dimensional data. (2) A unique three-dimensional shape is gained from a plurality of two-dimensional images via a geometrical calculation unit that performs processing similar to the stereoscopic view processing. (3) The “viewpoint” data assigned to the three-dimensional shape are geometrically calculated, and displayed again on a display apparatus as a two-dimensional image.

Preferably, said front view image generating unit comprises a corresponding point searching unit for extracting mutually corresponding geometrical feature points from each of said plurality of images; a three-dimensional shape identifying unit for analyzing said plurality of images based on said geometrical feature points to identify the three-dimensional shape of said object; and a geometrical calculating unit for setting the viewpoint to generate a mirror image of said object based on said three-dimensional shape of the object, and generating a two-dimensional image viewing said object from said viewpoint.

First, the front view image generating unit grasps the three-dimensional shape of the object based on a plurality of images taken from a plurality of different viewpoints. Then, the data gained based on the three-dimensional shape is geometrically converted, and converted into a front view image. The corresponding point searching unit specifies the corresponding point within the gained image either automatically or according to external instructions. Selected as corresponding points are, for example, the sides or vertices of a three-dimensional body, or points that are brighter (darker) than their surroundings. When the three-dimensional shape of the object has been recognized, the parameters for gaining the mirror view (e.g., viewpoint and/or viewing rays) are set.

Preferably, the present invention further comprises a position designating unit for designating a portion of the images of the object displayed on said display unit, wherein said signal processing unit performs at least one of an expansion processing and a reduction processing for the portion designated by said position designating unit.

The position designating unit may be, for example, a common pointing device such as a mouse or track ball, or the position may be directly designated on the screen by providing a touch screen on the display device. One example of the expansion and reduction processing is the so-called zoom angle processing function.

Preferably, said signal processing unit performs at least one of an expansion processing and a reduction processing simulating the function of a concave mirror or a convex mirror. When accurately simulating an actual mirror, for example, the object is displayed clearly in the center and somewhat out of focus in the surrounding, as in the case of actual concave or convex mirrors. However, this kind of processing is not essential to the present invention.

Preferably, said signal processing unit comprises storage means, stores image data from said front view image generating unit at least temporarily, and thereafter replays said image data to perform at least one of recording, replaying, slow replaying, fast forwarding, and temporary suspending processing.

In this case, for example, functions similar to that of a video tape recorder can be realized.

Preferably, said signal processing unit Comprises delay means for delaying image data from said front view image generating unit at least temporarily.

The delay period may be fixed or variable. According to this function, for example, it is possible to clearly see how one's own face with closed eyes looks like, or to look at oneself from the back or one's own face seen from the side. This function could not be realized with conventional mirrors.

Preferably, said display device is a plate-shaped liquid crystal display device, and said plurality of imaging devices are arranged at least on the upper left and right ends of said liquid crystal display device.

Preferably, said display device is a display device using a CRT, and said plurality of imaging devices are arranged at least on the upper left and right ends of said display device.

Preferably, said plurality of imaging devices are further arranged in the center of the lower end of said liquid crystal display device.

Preferably, said signal processing unit and said front view image generating unit are implemented by a portable personal computer.

Preferably, the present invention comprises communications means that is at least connectable to the Internet and that can transmit an image generated by said front view image generating unit.

The storage medium according to the present invention stores a program to cause a computer to implement a digital image processing characterized by comprising a first step of gaining images of an object viewed from a plurality of different viewpoints in the surrounding of a display device; a second step of identifying the three-dimensional shape of said object based on said plurality of images; a third step of generating an image of said object based on the identification results in said second step; a fourth step of receiving the image generated at said third step and performing certain signal processing; and a fifth step of receiving the image signals resulting from the processing in said fourth step and displaying an image, wherein, when said object is placed in front of said display device, the front view image of said object viewed from said display device is generated, and a mirror image of said object is displayed on said display device.

The storage medium according to the present invention stores a program to cause a computer to implement at least a portion of the mirror functions realized through a digital image processing that is characterized in gaining an image of an object viewed from a plurality of different viewpoints in the surrounding of a display device; identifying the three-dimensional shape of said object based on said plurality of objects; generating an image of said object based on the identification results; receiving the generated images and performing certain signal processing; and receiving the resulting image signals and displaying an image, wherein, when said object is placed in front of said display device, the front view image of said object viewed from said display device is generated, and a mirror image of said object is displayed on said display device.

The medium includes floppy disc, hard disc, magnetic tape, magneto-optic disc, CD-ROM, DVD, ROM cartridge, RAM memory cartridge with battery backup, flash memory cartridge, non-volatile RAM cartridge, etc.

Also included are communications media such as telephone lines and other cable communications media, and microwave circuits and other wireless communications media. The Internet is included in the communications media.

A medium is defined as any kind of physical means for storing information (mainly digital data, programs), used for causing computers, dedicated processors and other processing apparatuse stoper form certain functions. In other words, it may be any means for downloading programs onto a computer and for causing the computer to implement certain functions.

### BRIEF DESCRIPTION OF THE DRAWINGS

FIG. 1 is a schematic structural view of the digital mirror according to embodiment 1 of the present invention;

FIG. 2 is a schematic external view of the digital mirror according to embodiment 1 of the present invention;

FIG. 3 is a schematic external view of another digital mirror according to embodiment 1 of the present invention;

FIG. 4 is a view explaining the movement principles of the digital mirror according to embodiment 1 of the present invention; and

FIG. 5 is a view explaining the movement principles of the digital mirror according to embodiment 1 of the present invention.

### DESCRIPTION OF THE PREFERRED EMBODIMENTS

### Embodiment 1

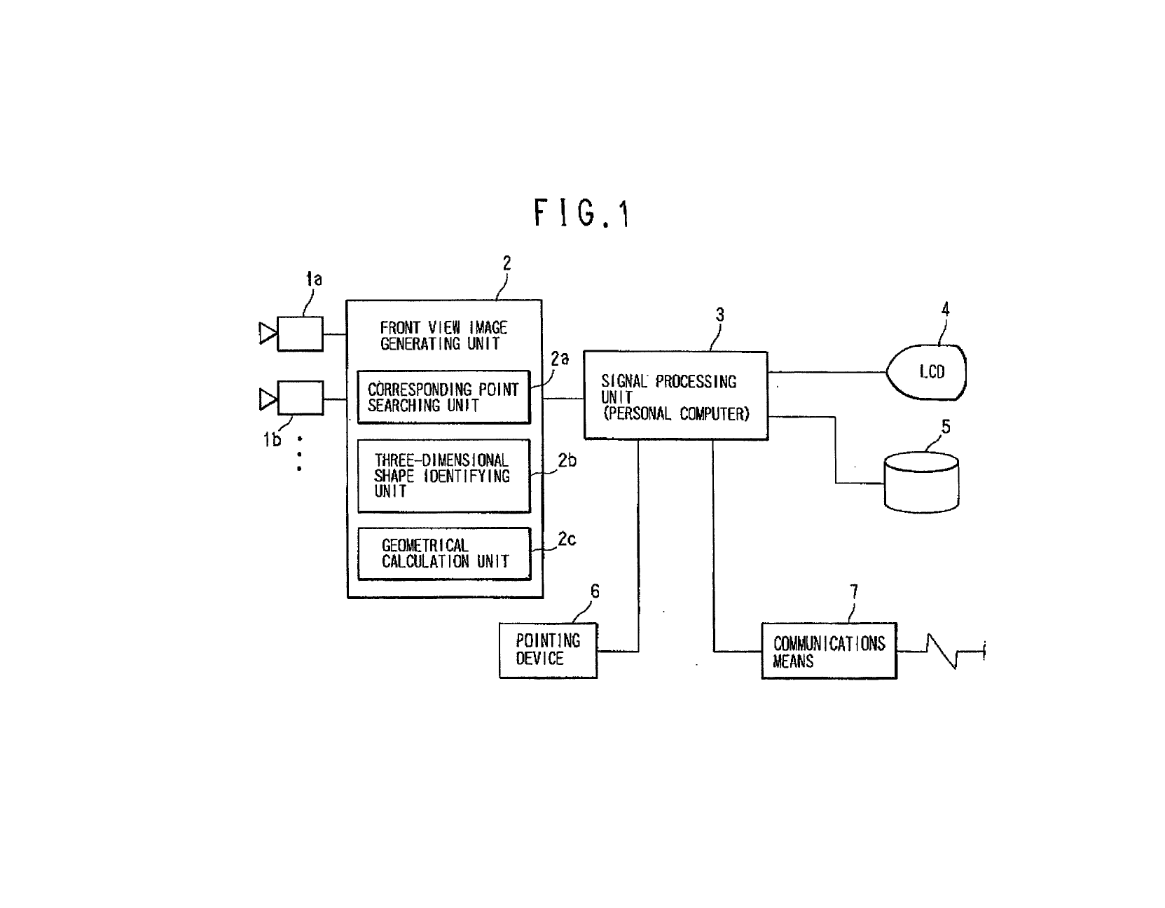

FIG. 1 is a structural view showing an outline of the apparatus according to an embodiment of the present invention (digital mirror). The image data (signals) obtained from a plurality of cameras 1a, 1b, . . . are input into a front view image generating unit 2. In front view image generating unit 2, a corresponding point searching unit 2a searches the mutually corresponding points by analyzing the plurality of images. These corresponding points are analyzed by a three-dimensional shape identifying unit 2b , and the three-dimensional shape of the object is identified. Based on the identified results, the viewing rays are set, and the data is geometrically converted or varied based on the set viewing rays, thereby generating a front view image that would be gained by looking into a mirror. Furthermore, camera 1 need only be a plurality of cameras, regardless of whether 2, 3, 4 or more. Two or three are desirable from the practical aspect.

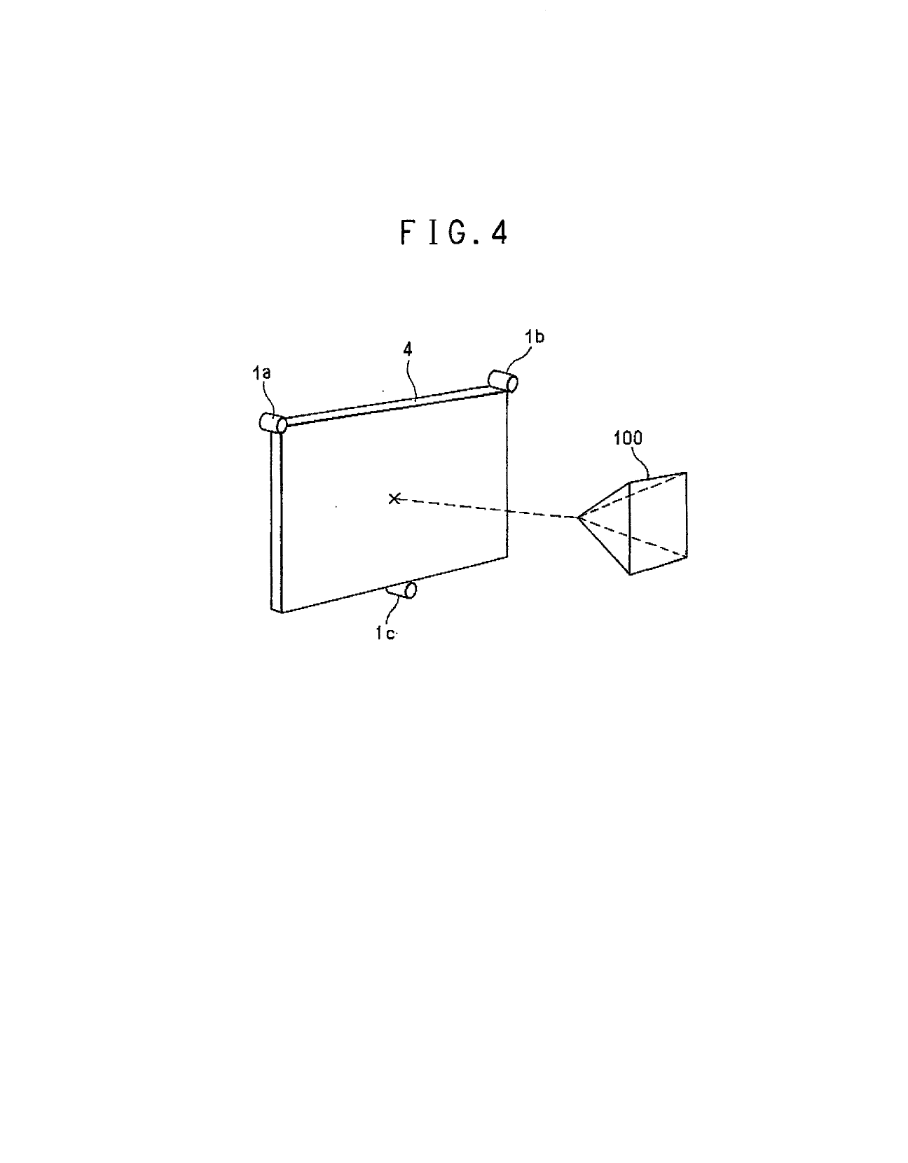

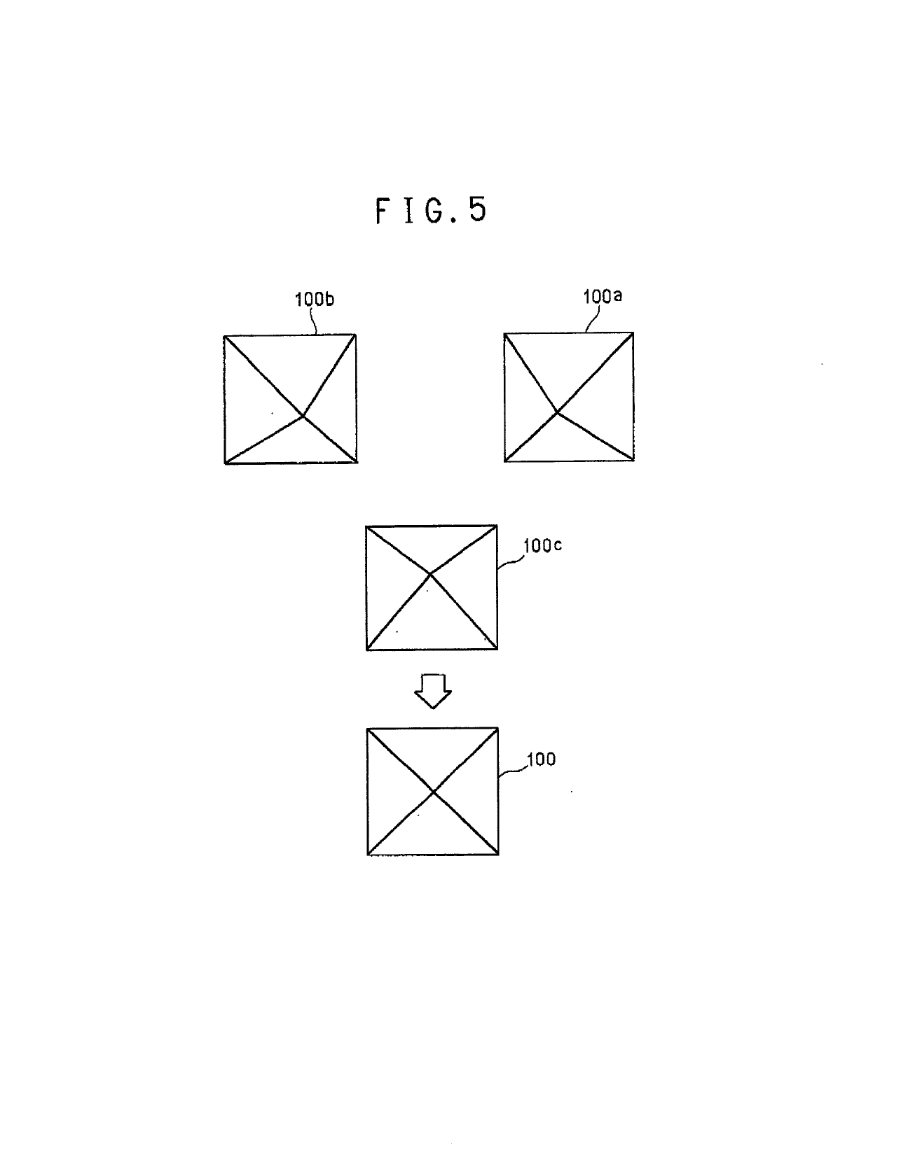

The processing of the front view image generating unit will be described in further detail based on FIGS. 4 and 5. FIG. 4 is a model view of a digital mirror comprising cameras 1 at the left and right upper ends and the center of the lower end of a plate-shaped liquid crystal display apparatus (LCD) 4. An object 100 is placed on the normal vector intersecting substantially the center of LCD 4. Normally, the face of the user is located at this position, but for convenience of explanation, a quadrangular pyramid is used as an example. When quadrangular pyramid 100 is shot by cameras 1a, 1b, and 1c, images 100a, 100b, and 100c in FIG. 4 are obtained. Image 100a is shot by camera . . . 1a, and viewed from LCD 4, this image is a view of pyramid 100 from the left side. Image 100b is shot by camera 1b, and is a view of pyramid 100 from the right side. Image 100c is shot by camera 1c, and is a view of pyramid 100 from the bottom. If there are at least two images seen from different view points located relatively adjacent to each other, then it is possible to identity a unique three-dimensional shape from a plurality of two-dimensional images through a geometrical calculation processing similar to the stereoscopic view processing. In order to perform this processing by a computer, it is necessary to specify the feature points. In the present example, the apexes of quadrangular pyramid 100 are selected. When the feature points have been specified for all images, the correspondence between these feature points is calculated. In this way, it is analyzed at which position in each image the same portion of pyramid 100 is located. Based on this analysis, the three-dimensional shape of pyramid 100 is identified. According to image 100a, the apex is on the left side, so it is clear that pyramid 100 is at the left of camera 1a. In this way, the three-dimensional shape is identified. Thereafter, the viewpoint is set for example substantially in the center of LCD 4, and based on this viewpoint, an image pyramid 100 is generated. For example, image 100 as shown in FIG. 5 is obtained.

In FIG. 1, signal processing unit 3 receives the front view image processed as above from front view image generating unit 2, and performs various processing. In other words, various processing at the time of display (reflection) is performed.

Examples are the zoom and wide angle processes. A certain portion of the whole image reflected in a mirror is instantaneously enlarged or reduced. The selection of the portion to be enlarged or reduced and the processing to be performed is designated by a pointing device 6 such as a mouse. If the surface of LCD 4 is a touch panel, it is possible to touch an arbitrary portion of the image to enlarge or reduce such portion instantaneously.

Another example is the processing of pictures. Processing such as changing the color or brightness of the picture taken by camera 1, changing the shape or size of the image of the object on the screen, overlapping a plurality of images, synthesizing images, and deleting or inserting portions of images is performed. The processed images correspond with the movements of the actual object in real time.

Further examples are freeze-frame picture processing, recording processing, storage processing and replay processing. It is possible to store images on the mirror (LCD 4) as static images on an external memory apparatus such as a hard disk, or an internal memory apparatus such as a semiconductor memory. Recording images as dynamic images and replaying such images is also possible.

Another example is the delayed display processing. According to this processing, the image generated by front view image generating unit 2 is not displayed as is on LCD 4, but temporarily stored, and replayed and displayed after a predetermined period of time has passed (e.g., 1 or 2 seconds to approximately 1 minute). This processing is useful when trying to see how one's own face with the eyes closed looks like, or when looking at one's own face seen from the back or side.

A further example is the processing through the Internet. It is possible to transfer the data of the image on the mirror (LCD 4) via communication means 7 to the Internet. Also, various image data may be captured from other digital mirrors or other image data sources.

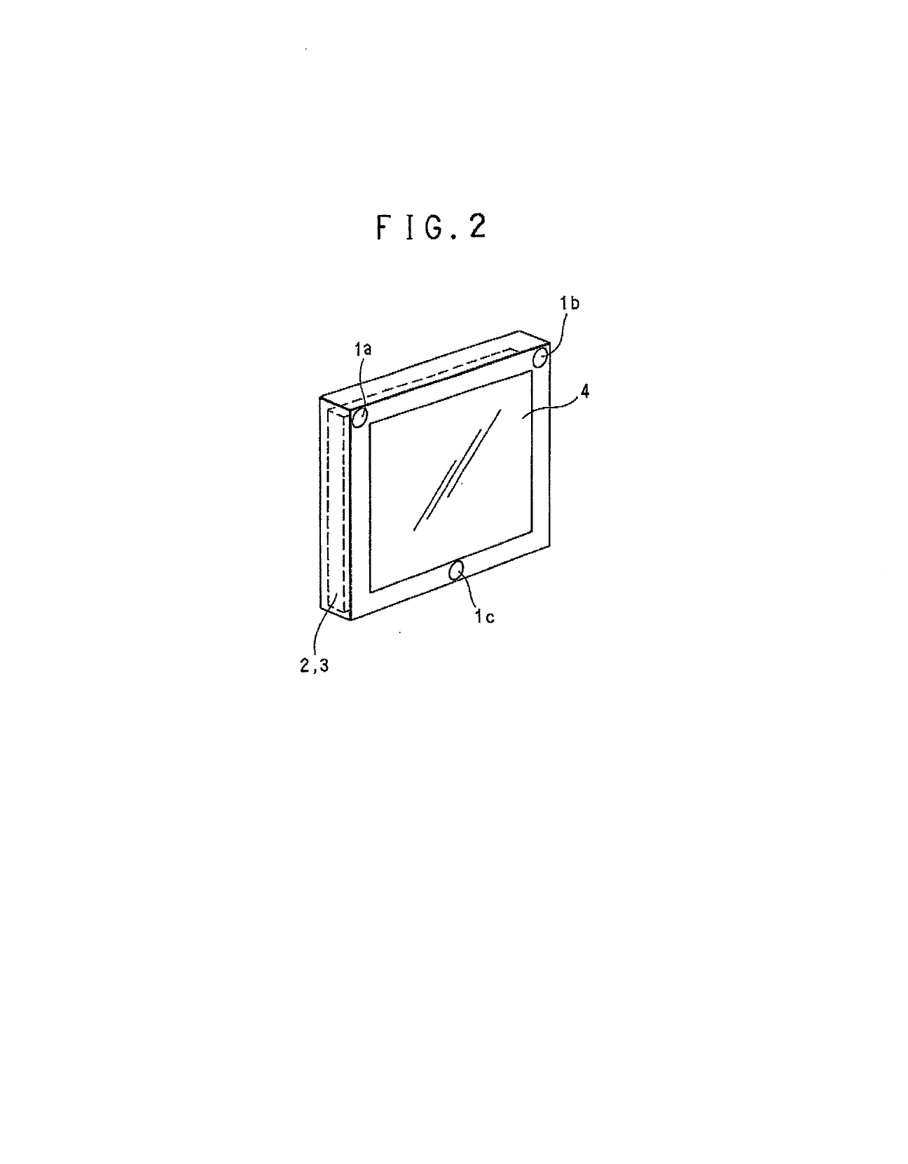

FIG. 2 is a variation of the digital mirror in FIG. 1. Three CCD cameras 1a, 1b and 1c are provided around LCD 4. At the back of LCD 4, a computer is provided which functions as front view image generating unit 2 and signal processing unit 3. These are all stored integrally in one case.

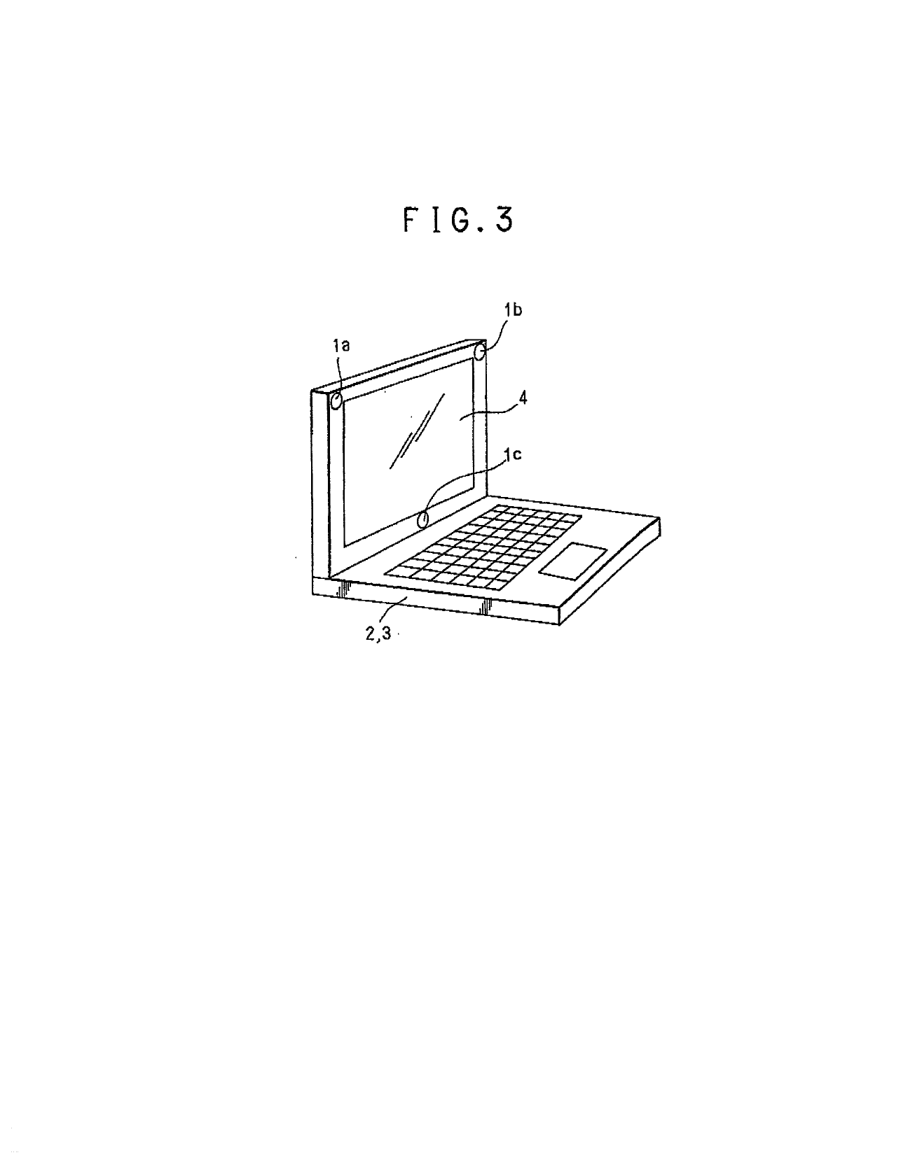

Another variation is shown in FIG. 3. The digital mirror in FIG. 3 is provided on a common notebook computer.

### Embodiment 2

The description above related to the basic structure and movements of the digital mirror. Now, an application of the digital mirror will be described below.

One application is a cosmetics simulator. Conventional cosmetics simulators applied various cosmetics on a static image that was shot, and simulated what kind of cosmetics were appropriate. By using the digital mirror according to the present invention, real time simulation is possible by changing the direction and expression of the face.

Some functions of the cosmetics simulator are the makeup and image changing functions. A makeup style corresponding to the user's taste (for parties, for natural-style makeup) is chosen from among cosmetics simulation screen files stored in advance in an external storage apparatus 5 of the digital mirror, and pasted on the user's face shown on the digital mirror. Certain makeup can be performed on the position of the face on the screen. The colors used can be designated, too, so professional-like makeup is possible. By selecting a desired eyebrow shape from among the eyebrow image files, ideal eyebrows can be drawn. As the correspondence between the feature points in the image is grasped by corresponding point searching unit 2a, the feature point can be set to the portion of the eyebrow in the face, and by putting a marker on such portion of the image, such as by dotted lines, the eyebrow can be drawn simply and accurately.

Another application is a beauty parlor simulator. A hair style corresponding to the user's taste is chosen from among hairstyle image files stored in advance in external storage apparatus 5, and pasted on the user's face shown on LCD 4. This processing allows a simple and accurate hair change. There is no unnaturalness as with synthesized photographs, and the hairstyle can be checked from various angles. In this case, it is possible to provide a delay function in the digital mirror, thereby allowing the user to check the hairstyle from the back of the head as if photographed from the back.

A further application is a cosmetic surgery simulator. An image corresponding to the user's taste is chosen from among cosmetic surgery image files (e.g., image data of parts of the face, such as eyes, nose and lips) stored in advance in external storage apparatus 5, and pasted on the user's face shown on LCD 4. This processing allows the user to compose an ideal face by choosing the surgery parts.

A still further application is a fitting simulator. The simulator is provided with an LCD 4 of a size that can display a person in full length, and an image corresponding to the user s taste is chosen from among clothes image files stored in advance in external storage apparatus 5, and pasted on the user's body. This processing is especially useful for underwear and swimsuits, which are not suitable for fitting.

Furthermore, as the correspondence between the feature points in the image is grasped by corresponding point searching unit 2a, the face on the screen changes in real time according to changes in direction or expression of the face. Therefore, the user can see the own face from the side, and experience a realistic image of makeup or hairstyle changes, and a realistic post-surgery image.

By providing the digital mirror with an Internet connecting function, it is possible to capture the data of the newest cosmetics colors, the makeup or hairstyle of the favorite actress, accessories, etc., via the Internet and try them out on the screen.

By successively recording the images of the digital mirror, use as a supporting system for ballet or dance lessons is also possible.

A further application of the digital mirror is an entertainment apparatus. For example, by providing many digital mirrors inside Cinderella's castle in an amusement park, the entering user can view oneself as Cinderella reflected on glass. AS the correspondence between the feature points in the image is grasped by corresponding point searching unit 2a, the image on the digital mirror moves corresponding to the user's movements. Therefore, the user will experience a feeling as if being in a dream, and become the heroine in the animated picture world.

Another application of the digital mirror is a supporting apparatus for sports lessons such as ballet, dance and golf. For example, when the user performs a golf swing before the digital mirror, the image is thereafter replayed in the normal or slow mode. Within this image showing the user in full length during a golf swing, the points to be improved are indicated by a cursor, and advice and comments are shown, too.

As used herein, means is not limited to physical means but includes cases where the functions of such means are realized through software. Furthermore, the functions of one means may be realized through two or more physical means, and the functions of two or more means may be realized through one physical means.

We claim:

1. A mirror realized through digital image processing, characterized in comprising:
a plurality of imaging devices for respectively obtaining images of an object seen from various viewpoints;
a front view image generating unit for identifying the three-dimensional shape of said object based on a plurality of images obtained from said plurality of imaging devices, and generating a two-dimensional image viewing said object from a given viewpoint based on the identified three-dimensional shape;
a signal processing unit for receiving the output from said front view image generating unit and performing a predetermined signal processing; and
a display device for displaying an image based on the output from said signal processing unit;
wherein said plurality of imaging devices are arranged in the surrounding of said display device, and when said object is placed in front of said display device, said front view image generating unit generates the front view image of said object viewed from said display device, and a mirror image of said object is displayed on said display device.

2. A mirror realized through digital image processing according to claim 1, characterized in that said front view image generating unit comprises:
a corresponding point searching unit for extracting mutually corresponding geometrical feature points from each of said plurality of images;
a three-dimensional shape identifying unit for analyzing said plurality of images based on said geometrical feature points to identify the three-dimensional shape of said object; and
a geometrical calculating unit for setting the viewpoint to generate a mirror image of said object based on said three-dimensional shape of the object and generating a two-dimensional image viewing said object from said viewpoint.

3. A mirror realized through digital image processing according to claim 1, characterized in further comprising a position designating unit for designating a portion of the mirror image of the object displayed on said display unit, wherein said signal processing unit performs at least one of an expansion processing and a reduction processing for the portion designated by said position designating unit.

4. A mirror realized through digital image processing according to claim 3, characterized in that said signal processing unit performs at least one of an expansion processing and a reduction processing simulating the function of a concave mirror or a convex mirror.

5. A mirror realized through digital image processing according to claim 1, characterized in that said signal processing unit comprises storage means, stores image data from said front view image generating unit at least temporarily, and thereafter replays said image data to perform at least one of recording, replaying, slow replaying, fast forwarding, and temporary suspending processing.

6. A mirror realized through digital image processing according to claim 1, characterized in that said signal processing unit comprises delay means for delaying image data from said front view image generating unit at least temporarily.

7. A mirror realized through digital image processing according to claim 1, characterized in that said display device is a plate-shaped liquid crystal display device, and said plurality of imaging devices are arranged at least on the upper left and right ends of said liquid crystal display device.

8. A mirror realized through digital image processing according to claim 1, characterized in that said display device is a display device using a CRT, and said plurality of imaging devices are arranged at least on the upper left and right ends of said display device.

9. A mirror realized through digital image processing according to claim 8 or 9, characterized in that said plurality of imaging devices are further arranged in the center of the lower end of said liquid crystal display device.

10. A mirror realized through digital image processing according to claim 7, characterized in that said signal processing unit and said front view image generating unit are implemented by a portable personal computer.

11. A mirror realized through digital image processing according to claim 1, characterized by comprising communications means that is at least connectable to the Internet and that can transmit an image generated by said front view image generating unit.

12. A medium storing a program to cause a computer to implement digital image processing, characterized by comprising:
a first step of gaining images of an object viewed from a plurality of different viewpoints in the surrounding of a display device;
a second step of identifying the three-dimensional shape of said object based on said plurality of images;
a third step of generating an image of said object based on the identification results in said second step;
a fourth step of receiving the image generated at said third step and performing certain signal processing; and
a fifth step of receiving the image signals resulting from the processing in said fourth step and displaying an image,
wherein, when said object is placed in front of said display device, the front view image of said object viewed from said display device is generated, and a mirror image of said object is displayed on said display device.

13. A medium storing a program to cause a computer to implement at least a portion of the mirror functions realized through a digital image processing that is characterized in gaining an image of an object viewed from a plurality of different viewpoints in the surrounding of a display device; identifying the three-dimensional shape of said object based on said plurality of objects; generating an image of said object based on the identification results; receiving the generated images and performing certain signal processing; and receiving the resulting image signals and displaying an image, wherein, when said object is placed in front of said display device, the front view image of said object viewed from said display device is generated, and a mirror image of said object is displayed on said display device.
